(19) United States
(12) Patent Application Publication
(10) Pub. No.: US 2003/0222976 A1
(43) Pub. Date: Dec. 4, 2003

(54) Methods and apparatus using algorithms for image processing

(76) Inventor: Mel Duran, Los Alamos, NM (US)

Correspondence Address: CAHN & SAMUELS LLP, 2000 P STREET NW, SUITE 200, WASHINGTON, DC, 20036, US

(21) Appl. No.: 10/357,513

(22) Filed: Feb. 4, 2003

Related U.S. Application Data
(60) Provisional application No. 60/353,173, filed on Feb. 4, 2002.

(51) Int. Cl. H04N 13/00; H04N 15/00

(52) U.S. Cl. 348/43

(57) ABSTRACT

Disclosed are systems and methods for computer-assisted visual comparison of images. The disclosed system using invention's image processing algorithms promotes optimization of sensitivity and noise suppression beyond human capability to determine the differences or changes between an original and archived set of pictures.

This Application claims the benefit of Application Serial No. 60/353,173 of MELVIN G. DURAN filed Feb. 4, 2002 for IMAGE PROCESSING ALGORITHMS, the contents of which are herein incorporated by reference.

Appendices A-C respectively named on Feb. 2, 2003, as computervisualinspection.pro (506 KB), radiologicalimagecorrelation.pro (508 Kb) and securityimage.pro (202 KB) are incorporated herein by reference.

### BACKGROUND OF THE INVENTION

1. Field of the Invention

This invention relates generally to systems and methods for processing data from 2 or 3-dimensional pixel arrays of digitized pictures or images and, more particularly, to systems and methods for comparison of a pair of ‘like’ images for the purpose of learning the differences between them.

2. Description of Related Art

It is well known that digitizing a picture produces random noise within the resulting digitized picture in which the noise is usually unique to the individual picture. It is also known that differences between any pair of digitized pictures can be derived by simply subtracting one picture from the other from which the differences will also include the random noise differences and differences due to poor alignment of the pictures. Either noise or misalignment cause the generation of a large number of differences which produce comparisons that are not particularly useful and may actually mask useful information.

One method of detecting abnormalities or changes in an image is to manually compare the image with a duplicate reference image. Human comparison can be time consuming and tedious and, therefore, prone to error. Furthermore, human comparison is limited to the threshold or minimum sensitivity of the human eye to determine the differences or changes between contrast and brightness, the smallest size of the changes or the ability to detect them amongst a busy background in the images, all of which may contribute to errors. Machine comparison typically is more sensitive. A machine or computer, may compare two images and generate a message when they detect a difference. Machine comparison, however, is prone to inaccuracies, resulting in false difference messages, or false alarms. A reason for these inaccuracies is that digitizing an image produces random noise within the resulting digital image, in which the noise is unique to the individual image. Machine-detected differences between any pair of digitized pictures thus may include these random noise differences and other inaccuracies such as those due to a poor pixel to matching pixel alignment between the images. Thus, machine comparison may generate many differences that are not useful and that may mask useful information.

### SUMMARY OF THE INVENTION

It is an object of the invention to overcome image comparison problems created by noise and or misalignment.

It is another object of this invention to employ machine comparison thereby minimizing errors resulting from either detection threshold errors or differences in contrast or density that are beyond what may be performed manually by a human.

Still another object of the invention in one embodiment is to reduce false alarm rates, provide user adjustment of the observation target contrast and size while permitting user adjustment of a reconnaissance area thereby reducing or eliminating changes caused by natural motion such as clouds, trees, etc.

Another object of this invention is to provide automatic system adjustment to compensate for ambient light change.

Yet another object of this invention to provide a system for autonomous and automatic intrusion detection and warning.

It is an object of the present invention to provide methods and apparatus for image processing in a computer software form that can compare current pictures or images with archived duplicates. The compared images may be displayed in one or more selected formats providing useful differences between them with a capability that is beyond the capability by human comparison and machine-vision systems.

Further objects of the invention herein are to provide high speed difference detection and high sensitivity minimum of 5 pixels at any distance and area width

In security field applications, additional objects of the invention include providing broad area and far distance coverage, 5 pixel sensitivity permits using a single camera thereby reducing equipment cost, coverage to select distance and area width. Virtual real time automatic and autonomous intrusion detection, and reduces both the number of personnel required for monitoring and personnel fatigue from staring at monitors.

Still another object of this invention is to reduce costs by employing legacy equipment.

These and other objects of the invention are achieved by a method comprising:

displaying an image representing a first signal;

receiving a second signal, the second signal identifying a feature in the image; and

comparing the first signal to a third signal, responsive to the second signal.

Still other objects of the invention are satisfied by a system comprising:

a display that displays an image representing a first signal;

circuitry that generates a first signal, to send an image signal to the display;

circuitry that receives a second signal, the second signal identifying a feature in the image; and

circuitry that compares the first signal to a third signal, responsive to the second signal.

For the purpose of better understanding the invention, the following definitions are provided.

‘Align’ refers to adjusting the x and y coordinates of each pixel in the copy picture to be the same as their matching counterparts in the original picture.

‘Digitize’ refers to converting a visual representation of 2-dimensional picture into a 2-dimensional array or map of many smaller areas called pixels. Each pixel in an array represents the numerical average value within the area of the pixel of the color of the picture in the pixel area.

‘Format’ refers to the type of software process or method used to create a digitized picture. The type of picture is usually indicated by including the type of format as an extension to the name of the picture.

‘Match’ refers to adjusting, in terms of size and orientation, the features in the copy picture to be the same as those in the original picture.

‘Original’ and ‘Copy’ pictures are terms used to differentiate between any pair of pictures of the same object.

‘Picture’ refers to a 2-dimensional visual representation or a 2-dimensional data array or map of all pixels representing the picture. The words pictures and images are used interchangeably throughout the text.

‘Pixel’ refers to a unit of area derived by dividing a picture into smaller areas. A pixel may represent the average value of the color of the picture in the area represented by the pixel or a numerical value representing the amount of difference after subtracting pixels. A visual representation or reconstruction of the picture is the formation of an array with all pixels at their specific x and y locations within the array.

‘Operating system’ and ‘program’ are used interchangeably and refer to the entire system of software used in processing the pictures from start, input pair pictures, to finish, show, if any, all the differences between the pictures.

Product(s) refers to the digital information processing system has the algorithms embedded in their operating software.

‘Subtraction’ or ‘Subtracting’ refers to the process of subtracting the 2-dimensional array or map of pixels representing a 2-dimensional picture from an equivalent array or map representing another. The process subtracts the numerical pixel value in one picture from the numerical value of the matching pixel in the other picture. This process continues until all pairs of pixels in the arrays or maps have gone through the process with the numerical values of each difference being stored as a separate array.

‘Useful’ refers to information other than for example data associated with random noise or differences in contrast or size of features that may not be important or of interest to the operator.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

The foregoing and other objects and advantages will appear from the description to follow. In short, the invention herein, is directed particularly to image comparison methods and systems intended to maximize comparison efficiencies. In the description, reference is made to the accompanying drawing which forms a part hereof, and in which is shown by way of illustration a specific embodiment in which the invention may be practiced. This embodiment will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

References are made to the following description taken in connection with the accompanying drawings, in which:

FIG. 1 is a diagram representative of a system in accordance with a first preferred embodiment of the present invention

FIG. 2 is an example of images processed by the first embodiment of the invention.

FIG. 3 is a flow chart showing the processing performed by the algorithms embedded in program 57 in the first preferred system.

FIG. 4 is an example of program 57's reconstruction of images produced as a result of the first embodiment of the invention's algorithm's processing outlined in FIG. 3.

FIG. 5 is a diagram showing a system in accordance with a second preferred embodiment of the present invention.

FIG. 6 is a diagram showing a system in accordance with a third preferred embodiment of the present invention.

FIG. 7 is an example of a security system computer monitor depicting an intrusion.

The drawings which are incorporated in and which constitute a part of this specification, illustrate embodiments of the invention and, together with the description, explain the principles of the invention and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY EMBODIMENTS

First Preferred Embodiment

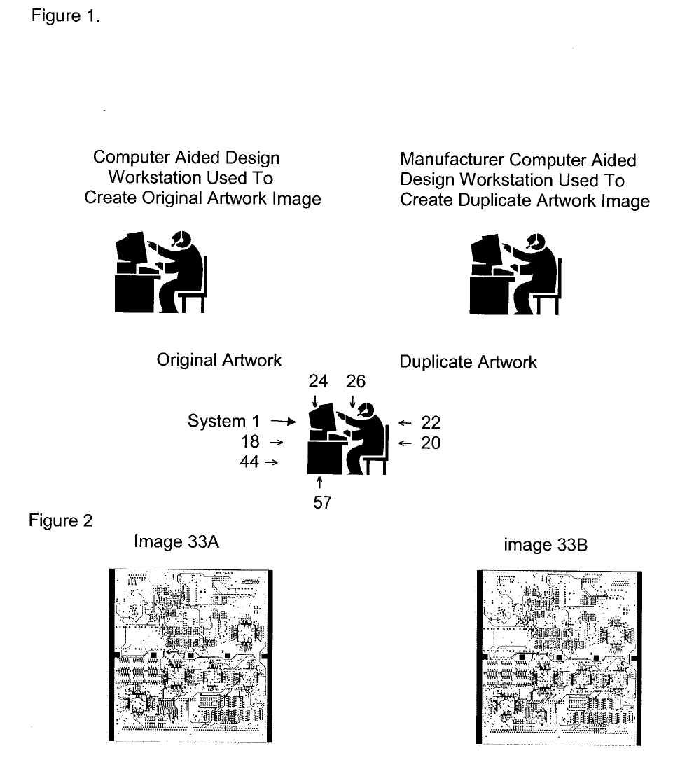

FIG. 1 is representative of the invention's image processing algorithms to compare the image of the original artwork created using a computer aided design (CAD) workstation with the manufacturing artwork, a duplicate independently created for actual manufacture of an electronic circuit board. This computer comparison of the images of original and duplicates provides a check for errors, even prior to manufacture, which typically is not possible to detect by human visual comparison, computer simulated electrical tests or machine-vision system checks.

FIG. 1 represents diagrammatically global or end-to-end system 1 process from creating an original circuit board artwork design to creating the duplicate that will be used for its manufacture. System 1 includes a generic computer aided design workstation (CAD) used to create the original artwork, a generic computer design workstation at a circuit board manufacturing facility used to create the duplicate artwork for manufacture of the circuit board and the generic personal computer (PC) that invention resides on to compare the original and duplicate artwork according to a preferred embodiment of the present invention.

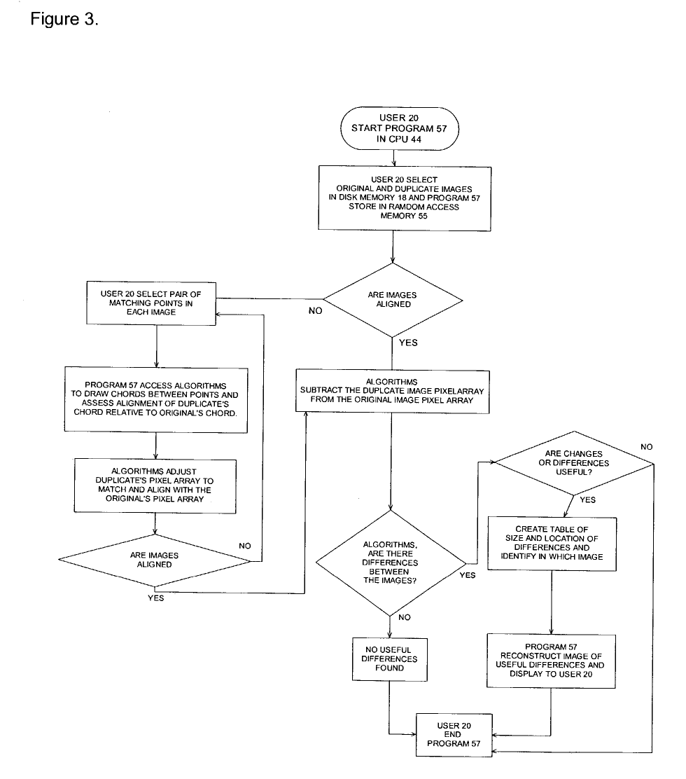

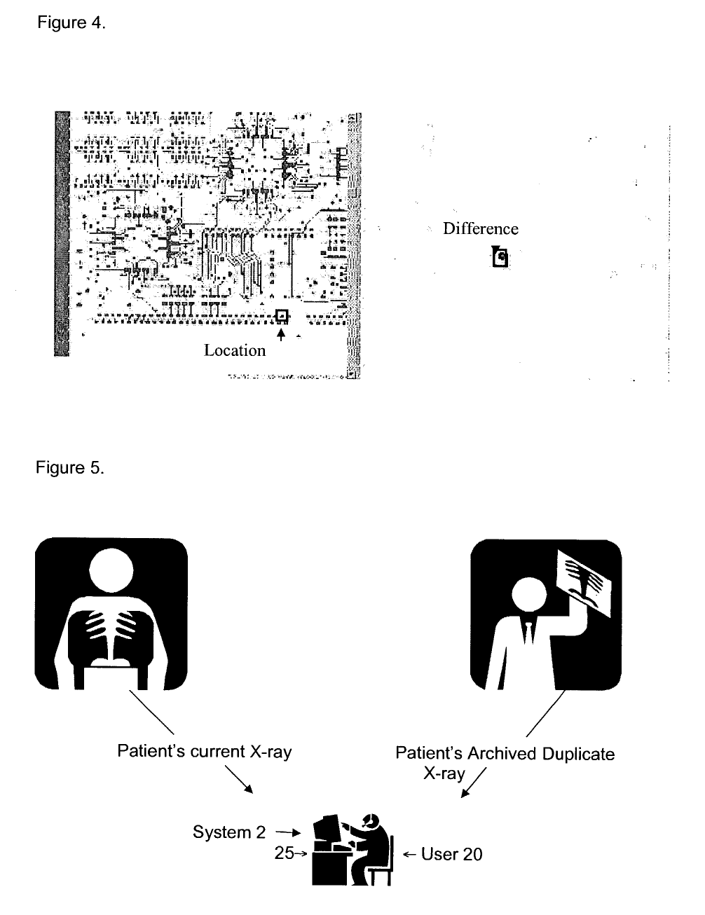

FIG. 2 depicts artwork (image 33A) created on a CAD workstation and duplicate artwork (image 33B) independently created at a manufacturing facility to be processed by invention's algorithms to check for errors prior to manufacture of the circuit board. The invention detects and assesses the differences between the original and duplicate circuit board artworks.

The personal computer (PC) referred to in FIG. 1 includes a central processing unit (CPU) 44, random access memory 55, and disk memory 18 for storing programs and digital images. Station 22 also includes a user interface having a cathode ray tube (CRT) display 24 and any conventional pointing device, which in this case is mouse input device 26.

The invention's algorithms are stored in any appropriate, conventional machine-readable form. In this case, the algorithms are contained in software form on disk memory 18. The CPU 44 executes invention's program 57 stored on disk memory 18, to compare the original and duplicate artwork images that are each digitized and also stored on disk memory 18.

At start-up of the program, a user 20 uses the pointer, e.g., mouse 26, or a keyboard 25, to select image processing functions. Each function accesses the appropriate algorithm embedded in the invention's software program to perform the selected function. This process proceeds sequentially through prescribed steps that ultimately produce a representation of all detectable differences between a pair of digitized images. In other words, the user 20 views a light signal 27 emitted by the CRT 24 and, in response to the viewed light signal 27, the user 20 generates feature selection data, which is a type of signal, and the CPU 44 receives the feature selection data. Hence the first step of image comparison program 57 is simply having the user select the images to be processed.

The CPU 44 executes program 57 to read the selected original and duplicate image files from disk memory 18 into program 57 memory 55.

The second step entails the CPU 44 executing program 57 to correlate the duplicate artwork image with the original artwork image pixel array data. In this step, program 57 displays pictures of the duplicate and original artwork images to the user. To commence the second step, the user selects and identifies matching pairs of points in each image, using the pointing device (mouse 26), that the program will use to assess the features of the images relative to each other. The program 57 processes the pairs of points selected by the user 20 in each image 33A and B to first measure the size of each point selected from which it calculates the X and Y coordinates of their centers (the centroid). The program 57 then develops a chord between the pair of points in each image which it then uses to assess the size and orientation of the image's pixel arrays relative to each other. Based on the size and orientation of the chords relative to each other, the algorithms in program 57 adjust the duplicate artwork image pixel array to precisely align and match it to the original artwork image pixel array.

The program 57 uses invention's algorithms to assess the size, rotation and translation of the duplicate image pixel array relative to the original image pixel array. Using the embedded algorithms, the program 57 adjusts the duplicate image's pixel array size, rotation and translation to precisely match the duplicate's with the original's pixel array image, At this point, the duplicate and original images have been precisely aligned by inventions algorithms.

More specifically, in this example, in response to viewing each of these images 33A and 33B, the user 20 manipulates the input device (mouse 26), to select the same pair of points in each image 33. As the user 20 manipulates the mouse 26, the CPU 44 detects the X-Y position of the cursor when the user 20 pushes the left button on the mouse 26. The pair of X-Y positions in each of the images are detected and converted to X and Y coordinates by the algorithms.

Using the original image's chord as the reference, the algorithms then measure the differences in size, angular rotation and translation (offset) of the duplicate image's chord. Using this data, the algorithms then adjust the duplicate image's pixel array to precisely match the original image's pixel array.

In summary, the process begins by the user selecting two features in the original picture that are also present in the duplicate and identifies each by clicking anywhere inside of feature's area. The X and Y coordinates and the pixel value at the points where the user clicks are used to find the center and size of the features. Following the feature selection process, the match and alignment of the pictures is assessed based on the size and orientation of chords drawn between the center points of the features. The assessment is performed in a Cartesian coordinate system, using the chords in each picture. The program 57 using the algorithms is capable of assessing the match and alignment of the two arrays and then making the necessary adjustments to the copy array to align and match it to the original.

The next or third step of the method of the invention herein involves the process that generates all the useful differences between the original work's pixel array image and the duplicate's pixel array image. This third step commences with user 20 selecting the program 57 differences function. At this point, program 57 begins processing images through invention's algorithms until all useful, detectable differences have been found and are ready to be viewed by the user 20. The algorithms commence processing by performing a pixel to matching pixel subtraction of the duplicate image pixel array from the original image pixel array. The remaining pixels in contiguous areas are then grouped and the size of the population of pixels in each group measured. The amplitude (8 bit digitized value) of each pixel in the group is also measured. With this information, the algorithms have all the information necessary to assess each pixel value and group size to determine if the differences are useful or not. The algorithms compare the size and the absolute value of each pixel's amplitude to default values and eliminate all differences below these threshold values from both the original and duplicate pixel arrays. To establish the size in the difference or change as useful information, the user may input selected default values of size of the difference and contrast value (8 bit digitized amplitude) or may rely on pre-selected, minimum default values contained within the program 57.

More specifically, the size of differences between any pair of pictures is determined by the remaining number of pixels, after subtraction, in a contiguous area. Additionally, the differences between the absolute values of each of the remaining matching pixel's amplitude is developed and stored in memory 55. The program 57 then uses default acceptance values for the number of pixels and the contrast or density, i.e. the 8 bit value, of a pixel to determine those pixels comprising useful information. As the original image may have data where the duplicate may not and the duplicate may have data where the original does not, the algorithms determine the differences relative to each of the images and store this information in memory 55. Hence, the user has the option of adjusting either the pixel or density threshold for either or both the copy and original picture arrays. Based on the X and Y coordinates for each difference in each array, the algorithms produce a table of the coordinates and pixel size value for each difference found between the two arrays. The program 57 then uses this table to reconstruct an image(s), preferably, in one or more separate windows, of the duplicate or original picture with a pointer to the location of a difference and an image containing only the difference(s) which may but preferably does not contain any background.

At this point, program 57, using the X and Y coordinate data from each pixel image array, provides the user with a view of the location of the first useful difference found as well as a view of only the difference.

The tables of location and pixel size permit program 57 to reconstruct a visual representation of the useful differences found. The visual representation is produced in at least two separate windows in order to provide an isolated view (no background) of each difference and a separate view of the duplicate or original artwork image with the location of the difference outlined by a box superimposed in the picture. As the user sequentially steps through each difference, the program 57 reads the difference's X and Y coordinates and pixel value from the data file to determine the position of boxes used as pointers that will surround the center of the location of the difference in the copy or original picture and a box that surrounds the difference being viewed. As the images may be enlarged for easier viewing, it then uses invention's algorithms to determine the x and y start positions of the enlarged array in each window to assure that the areas surrounded by the pointer boxes are always within view of the user.

The screen images described in connection with the third step. above is the last window of the program 57. In this screen, the program 57 walks the user sequentially through each difference and its location in the duplicate or original image for each pair of images. The program 57 assures that during each step, the area within each array being viewed is in each window with pointers to the correct location concurrently with the correct difference.

When the above described screen opens, it consists of two smaller windows that are already populated by the program 57; one with a picture of the original or duplicate image with a box already surrounding the location of the first difference; and one window already showing and pointing to the first difference found in the picture. The user may then sequentially step through each difference in each pair of original and duplicate images and sequentially step through each pair of images.

As each difference is brought to the windows for viewing, the program 57 reads the X and Y coordinates from the stored tables for its location in the picture. It then uses this information to create a box centered around the beginning of the first point of the difference at its location in the picture. Additionally, it creates a box centered disposed only about the difference for the isolated view. It then calculates the start position coordinates that the system will use to reconstruct the arrays in their respective windows. As the arrays may be larger than the viewing window, data from the final calculations assure the system will reconstruct the windows with the pointers to the location and difference within the view of their respective windows. Stepping through the last difference in the last pair of pictures is the end of the process.

The program 57 can compare one original to 100 copy pictures or 100 pairs of pictures each consisting of an original and a duplicate.

Each of the pictures, original and duplicate, are stored with a unique name in separate directories. As a convenience, the original and duplicate picture names may be the same as they are tracked and stored in separate directories by the program 57.

The program 57 contemplates conventional industry standard formats, such as jpg, gif, tif or bmp. Images may be input to subdirectories from such means as a scanner, the internet, or e-mail via a modem, or through the use of conventional machine readable media, e.g., floppy disk, cd rom, zip drive, flash memory card, memory stick, etc.

System 1 allows organization of data by projects, with each project having its own pictures, alignment data and the results of checking for differences between them. System 1 provides a window where the user identifies the picture file directories and the path to store and access them. System 1 stores the information on disk 18.

In summary, system 1, through program 57, compares points in the original picture with their counterpoints in the duplicate; align the X and Y coordinates of features in the duplicate picture with their matching counter parts in the original; adjust the size and orientation of the duplicate picture relative to the original; subtract the duplicate picture from the original; assess the differences produced between the pictures to derive the useful information; and store the data in a format that permits reconstruction of a 2-dimensional visual representation of only the useful differences.

System 1 effects processes that may be well beyond what may be performed by a human alone. For example, the differences in contrast or density of features between the pictures may be below the detection threshold of or the number of pixel differences may be less than obvious to the human eye and both types may be below the level of random noise.

In terms of their size and orientation to each other, two pictures from independent sources may appear to be the same to the human eye.

The system 1 provides a capability to assess differences as small as one pixel and differences in the contrast or shading between features in gray scale pictures both of which may be below the threshold of detection by the human eye. For example, differences of less than 3 db in contrast are below the threshold for detection by the human eye but are measured by the system 1 by numerically subtracting each duplicate's digitized pixel value from its matching pixel value in the original pixel array.

Second Preferred Embodiment

FIG. 5 shows system 2 in accordance with a second preferred embodiment of the present invention. System 2 is the application of the invention to the process of comparing a patient's current X-ray image that may be in a digitized or film form with archived X-ray images of the same patient. The purpose of the invention is to find all differences between the current and archived images of the X-rays and in particular those that are beyond the capability of detection by human or machine-vision systems comparison.

The program 157 e.g., radiologicalimagecorrelation.pro stored in memory 55 is executed by CPU 44, to compare patient's current digitized X-ray or mammogram picture or image that will be used by program 157 as the original or reference image 128 stored on disk memory 18 with patient's archived X-ray or mammogram images stored on disk memory 18 which program 157 will use as the duplicate images.

As in the steps outlined in the first preferred embodiment, the user 20 uses a mouse 26, or a keyboard 25, to proceed through the first second and third steps, detailed above in connection with the first preferred embodiment. As in the first preferred embodiment, it is first required to select the original and duplicate images, align the images by selecting matching features in both the original and duplicate displayed images, and then employing the alignment proceeding of the third step to produce and assess the detectable, useful differences therebetween. In other words, the user 20 views a light signal 27 emitted by the CRT 24 and, in response to the viewed light signal 27, the user 20 generates feature selection data to process the images according to steps one through three.

Third Preferred Embodiment

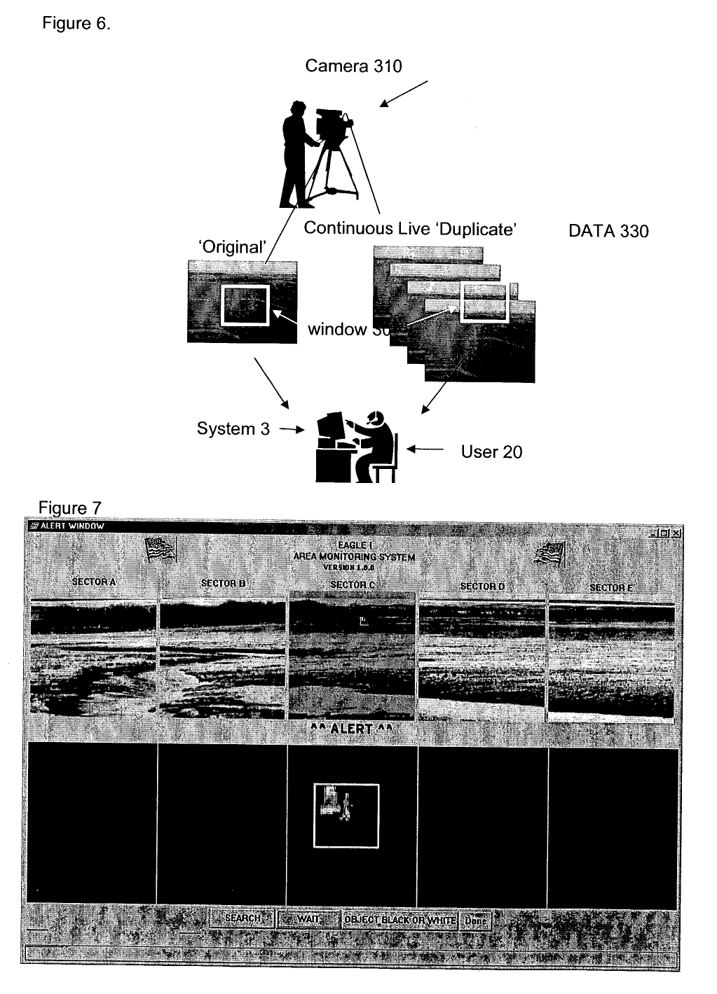

FIG. 6 depicts the system 3 in accordance with a third preferred embodiment of the present invention. System 3 is the application of invention to Closed Circuit TeleVision (CCTV) systems for the purpose of continuous comparison of live pictures, images, from a television (tv) camera. As above, the program 357, securityimage.pro is stored in memory 55 and executed by CPU 44. The purpose of this program routine is to detect and assess any differences found between an original image from the camera stored on disk memory 18 and continuous live pictures (duplicates) from the camera. Thus, the program 357 provides continuous, real time differential comparison of the latest tv picture (duplicate) with the last previously stored, original picture/image/profile. This system is particularly useful in the security filed as it provides an image comparison capability that permits a CCTV system to immediately alert security personal of a change and thereby provide early warning of potential threats. Invention's capability to eliminate or dramatically reduce random noise and ability to detect very low pixel differences, <5 pixels, permits highly sensitive detection capability. Thus, in short, this embodiment of the invention provides early warning of potential threat through high-speed detection, <0.03 seconds, and high sensitivity, detect 5 pixel differences in near real time.

The circuitry in the system 3 receives successive frames of data from the camera 310, represented in data 330 now in the memory 55, to display a moving image on the CRT 24.

The third preferred system may be applied to intrusion detection into controlled areas. The program may also be instructed by a user to make comparisons between successive frames of data from camera 310 rather than on a fixed original. In such a mode, this system is capable of detecting muzzle flashes or other very fast events.

A surveillance window 305 is designated by the user 20, using the mouse 26. The algorithms of this third system limits comparison of data from camera 310 to that of the image within window 305. Thus, the user may restrict the perimeter to exclude events occurring outside of the window, e.g., footpath or vehicular traffic. Thus, changes occurring outside of window 305 will not trigger a false alarm.

The preferred embodiments of the invention may be implemented with many different configurations of software modules associated with the image processing algorithms, depending on the application and desired integrated CCTV system optimization and design choices.

Although the preferred embodiments have been described above in a certain manner to facilitate ease of description of functionality, in an actual implementation processing may be preformed in serial fashion, in parallel, with software, with dedicated hardware, or in any manner to achieve desired optimizations.

Algorithm Operational Overview

Match and Align Pictures Algorithm (MAPA)

In terms of their size and orientation to each other, two pictures from independent sources may appear to be the same to the human eye. However, if they are not precisely aligned and matched to each other, a computer subtraction of one from the other usually results in large numbers of differences that are mostly not useful information. The purpose of this algorithm is to overcome this problem by assessing how well they are aligned and match each other for differences as small as one pixel which may be less than obvious for human detection.

The MAPA uses pairs of points selected by the user in each picture to measure the size of the features from which it calculates the x and y coordinates of their centers. It then uses the chords drawn between each pair of points to assess the size and orientation of the pixel arrays relative to each other and adjusts the copy array to align and match it to the original.

The algorithm is activated when the align pictures command is called by the user and begins its process with a sequence of four steps. This sequence of steps, the functions it performs and the results generated by it are detailed in following paragraphs. The process begins by the user selecting two features in the original picture that are also present in the copy and identifies each by clicking anywhere inside of feature's area. The x and y coordinates and the pixel value at the points where the user clicks are used to find the center and size of the features. Following the feature selection process, the match and alignment of the pictures is assessed based on the size and orientation of chords drawn between the center points of the features. The assessment is performed in a Cartesian coordinate system, using the chords in each picture. The algorithm is capable of assessing the match and alignment of the two arrays and then making the necessary adjustments to the copy array to precisely align and match it to the original.

The result of this process is that the algorithm will automatically achieve a best match of the copy array with the original based on the user selected features.

The user selects two points in the original picture that are also present in the copy. As prompted by the program, the user clicks anywhere inside the selected feature in the order required by the program, i.e. first original feature, first copy feature, second original, second copy.

Finding the center of each feature (the centroid) is required in order to develop the chords between the points in each pixel array that will be used to assess the alignment and match of the pictures. As the user clicks anywhere inside of each feature; the algorithm measures the value of the pixel pointed at by the user and assigns a 0 or 1 to the value if picture is black and white, or an 8 bit value for a gray scale picture; and determines the vertical and horizontal boundaries of the feature by measuring each pixel value along the vertical and horizontal axis passing through the point of the feature until it finds a change in the pixel value, an indication that this is a boundary of the feature; and from the boundary data, calculates the horizontal and vertical size of the feature, i.e. the number of pixels from edge to edge; performs a calculation to determine the x and y values of the center of the feature in the coordinate system and assigns these values to the x and y coordinates of the center of the feature.

After the two points in each picture have been processed, the algorithm performs an analysis of the chords produced between the points in each picture. The analyses are a comparison of all features of the chords to assess the differences between them and use this information to align and match the pictures. The comparisons are always relative to each other and adjustments are always made to the pixel array or map representing the copy picture. The adjustments performed may include as follows:

Determine if the size of the copy picture relative to the original is smaller or larger than the original from the length of the chords. If yes, calculate the amount and expand or shrink the copy picture.

Determine if the copy picture is or is not inverted horizontally and or vertically relative to the original by the direction of the chords. If yes, invert along the horizontal, vertical or both axis.

Based on the rotation and direction of rotation between chords, determine if the copy picture is or is not rotated, clockwise or counter clockwise. If yes, calculate the amount of rotation necessary to align the copy with the original, determine the direction and then rotate the copy picture.

Determine any horizontal or vertical offset between the chords. If yes, calculate the amount of offset in pixels, the direction and then shift the copy picture.

After making all adjustments to the copy picture, present the results in a view of the original picture with the copy overlaying it and highlight areas, may be as small as one pixel, that may not be aligned.

This concludes the automatic alignment process at which point the user assesses how well the pictures are aligned. If needed, the user then has the option to make manual coarse or fine adjustments or repeat the auto align process to achieve a final alignment.

Locate and Assess Differences Algorithm (LADA)

The purpose of this algorithm is to provide a capability to assess differences as small as one pixel and differences in the contrast or shading between features in gray scale pictures both of which may be below the threshold of detection by the human eye. For example, differences of less than 3 db in contrast are below the threshold for detection by the human eye but are measured by the algorithm by numerically subtracting one pixel value from another.

Once the picture pairs have been aligned to each other, the next step in the program is to subtract each copy picture from its matching original. As it is quite possible to have large numbers of differences between the pictures simply due to noise in the pictures or other factors, there are options for the user to set thresholds for how small a difference is useful information. These include a setting for the number of pixels in any one difference and a setting for the threshold on the dark to light value, contrast, of the pixel in one picture compared to its match in the other picture. The algorithm uses these settings to determine whether a difference is useful information or not and reports only those that are above the thresholds.

The LADA begins by performing a point to point subtraction of one pixel array from the other. During the process of subtracting, it assesses each difference found forming a pixel array of only the useful information. Any difference that is determined not to be useful is not reported. As it is possible for the copy picture to have information the original does not and vice versus, the algorithm checks for, assesses and tracks all detected differences. Based on the X and Y coordinates for each difference in each array, it produces a table of the coordinates and pixel value for each difference. The algorithm later employs this table to provide the operating system with the information necessary to reconstruct pictures in a window for the copy or original picture with a pointer to the location of the difference and one of the difference only, no background.

These windows provide an isolated view (no background) of each difference and a separate view of the copy or original picture with the location of the difference outlined by a box superimposed in the picture. As the user sequentially steps through each difference, the algorithm reads the difference's X and Y coordinates and pixel value from the data file to determine the position of a box that will surround the center of the location of the difference in the copy or original picture and a box that surrounds the difference being viewed. As the images may be enlarged for easier viewing, it then determines the X and Y start positions of the enlarged array in each window to assure that the areas surrounded by the pointer boxes are always within view of the user. The operating system then uses this information to reconstruct a visual representation of the pictures in each window.

The screen mentioned above is the last window of the program. In this screen, the program walks the user sequentially through each difference and its location in the copy or original for each pair of pictures. The algorithm assures that during each step, the area within each array being viewed is in each window with pointers to the correct location concurrently with the correct difference.

The size of differences between any pair of pictures is determined by the number of pixel differences between the arrays and or the differences between the values of each pair of matching pixels between arrays. The program uses default values for the number of pixels and the contrast or density, i.e. the 8 bit value, of a pixel. However, the user has the option of adjusting either the pixel or density threshold for either or both the copy and original picture arrays.

When the above mentioned screen opens, its two smaller windows are already populated by the operating system; one with a picture from the first pair of pictures and already pointing to the location of the first difference; and one already showing and pointing to the first difference found in the picture. The user may then sequentially step through each difference in each pair and sequentially step through each pair of pictures.

As each difference is brought to the windows for viewing, the algorithm reads the x and y coordinates for its location in the picture and in the useful differences array. It then uses this information to create a box centered around the beginning of the first point of the difference at its location in the picture. Additionally it creates a box centered around the difference for the isolated view of the difference. It then calculates the start position coordinates that the operating system will use to reconstruct the arrays in their respective windows. As the arrays may be larger than the viewing window, data from the final calculations assure the operating system will reconstruct the windows with the pointers to the location and difference within the view of their respective windows.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

What is claimed is:

1. A method comprising:
displaying an image representing a first signal;
receiving a second signal, the second signal identifying a feature in the image; and
comparing the first signal to a third signal, responsive to the second signal.

2. The method of claim 1 further including
receiving radiation from an object;
generating the first signal in response to the received radiation.

3. The method of claim 2 receiving includes receiving radiation reflected from the object.

4. The method of claim 3 wherein the radiation includes visible light.

5. The method of claim 2 receiving includes receiving radiation passed through from the object.

6. The method of claim 5 wherein the radiation includes X-rays.

7. The method of claim 1 further including
displaying an image;
receiving a signal identifying a feature in the second image.

8. The method of claim 7 wherein receiving a signal, identifying a feature, includes receiving the signal from an input device operable by human manipulation.

9. The method of claim 1 wherein the first signal is a representation of an instance of an object, and the third signal is a representation of another instance of the object.

10. The method of claim 9 further including performing generation the first signal multiple time per a performance of generation of the third signal.

11. The method of claim 1 wherein further including generating the first and third signals using a common radiation detector.

12. The method of claim 1 wherein comparing includes using the second signal to adjust a relative alignment of the first and third signals.

13. The method of claim 12 wherein using includes rotating the first signal.

14. The method of claim 12 wherein using includes translating the first signal.

15. The method of claim 1 wherein the method further includes displaying a result of the comparing step, while not displaying most of the second signal.

16. The method of claim 1 wherein the method further includes sequentially displaying results of the comparing step.

17. The method of claim 16 wherein processing further includes suppressing display of most of the second signal.

18. The method of claim 1 wherein comparing includes finding a contiguous part for which differences between the first and third signals are above a threshold.

19. The method of claim 18 wherein further including receiving the threshold from an input device.

20. The method of claim 19 wherein the input device acts to point.

21. The method of claim 20 wherein the input device includes a mouse.

22. The method of claim 1 wherein the image is moving.

23. The method of claim 1 further including receiving a user input to limit a part of the first signal processed by the comparing step.

24. The method of claim 23 wherein the user input defines a sub area in the first image.

25. A system comprising:
a display that displays an image representing a first signal;
circuitry that generates a first signal, to send an image signal to the display;
circuitry that receives a second signal, the second signal identifying a feature in the image; and
circuitry that compares the first signal to a third signal, responsive to the second signal.

26. A system comprising:
means for displaying an image representing a first signal;
means for receiving a second signal, the second signal identifying a feature in the image; and
means for comparing the first signal to a third signal, responsive to the second signal.
